(19) United States
(12) Patent Application Publication
(10) Pub. No.: US 2008/0193022 A1
(43) Pub. Date: Aug. 14, 2008

(54) Interface for fast pattern projection

(76) Inventors: Ian McDowall, Woodside, CA (US); Mark Bolas, Mountain View, CA (US)

Correspondence Address: CROCKETT & CROCKETT, P.C., 26020 ACERO, SUITE 200, MISSION VIEJO, CA, 92691, US

(21) Appl. No.: 11/087,198

(22) Filed: Mar. 22, 2005

Related U.S. Application Data
(60) Provisional application No. 60/554,869, filed on Mar. 22, 2004.

(51) Int. Cl. G06K 9/36; H04B 1/66

(52) U.S. Cl. 382/232; 375/E07.001; 375/240.01

(57) ABSTRACT

A method for projecting sequences of images from a standard digital source by packing the binary bit planes of an image is conveyed. The method enables 24× frame rates from a standard source using standard electrical interfaces.

This application claims priority to U.S. Provisional Application 60/554,869, filed Mar. 22, 2004.

The interface from a computer to a video projector transfers video data from the computer's frame buffer for display on the video projector. Video projectors reproduce the image one would see on a normal desktop monitor. The interface from the computer to the video projector has traditionally been a three component analog signal. New interfaces which transfer the image from the computer to the projector digitally are becoming available.

We are interested in projecting images at rates much faster than normal video rates for enhanced human viewing and machine vision applications. A typical video projector creates a new color image at between 50 to 120 frames per second with 60 Hz being the predominant US standard. Other potential interfaces include IEEE-1394, USB 2.0, or Gigabit Ethernet. These particular interfaces are potentially useful but do not deliver the sustained throughput needed to maintain high frame rates. Many of these standards also have the potential to drop frames, or to introduce non deterministic delays which, for machine vision, is not desired. There is an LVDS based standard for cameras called Camera Link which provides fast data rates, however, this standard generally presumes a camera is transferring data to a PC rather than having the PC be the source for the data.

Our interest in projecting images faster than these types of rates has a problem—interfacing to the standard interfaces used in PC graphics. We would like to use these standards for cost and availability reasons. The prevalent digital standard for such interfaces is called DVI.

Thus, we would like to interface a high frame rate projector to the standard DVI interface available on PC graphics cards. While we will use the term PC and computer fairly interchangeably in this disclosure, the concepts are equally applicable to other computing resources such as embedded systems, DSP based processors, and workstations.

A frame buffer is typically organized with some number of “bit-planes”. Each bit plane stores a frame of information for a single bit of color. For example, a graphics card may produce a 1024 by 768 by 24 bit image. The 1024 by 768 defined the number of horizontal and vertical pixels in the image. The 24 bits indicates that the image is made up 24 bits—typically 8 for red, 8 for green, and 8 for blue.

DVI comes in two flavors—single channel and dual channel. DVI is commonly understood to operate at rates of up to 165 MHz for a single channel—about 4 gigabits per second. Faster transmitters and receivers which operate up to 6.75 Gbps are also available from Silicon Image. These interfaces can, at lower speeds, interoperate with other DVI transmitters ad receivers. Because this is a new and evolving standard, we anticipate faster interfaces which adhere to this general standard.

Our discussion focuses on using 1024 by 768 by 24 bit images and single channel DVI but is equally applicable to other video resolutions and bit depths, and to dual channel DVI interfaces.

While DVI does have limited bandwidth, a single channel link at 165 Mhz could support rates of up to about 200 Hz for a 1024 by 768 24 bit image with small horizontal and vertical retrace periods, when unrolled, this link will support binary frame rates on the order of 4800 frames per second. Using faster interfaces will deliver higher performance. In order to interface to a fast projector, researchers have proposed using each bit plane of the video output to control, in time, the image displayed on a fast projector. Thus, for example, the frame of 1024×768×1 bit associated with the lowest bit of red (R0) might be displayed at time T1. At time T2, the 1024 by 768 frame associated with red bit R1 is displayed and so on. This permits the display of 24 frames of binary (on-off, no grayscale) data for a single video frame. The fast projector stores the incoming video in a local frame buffer which buffers up the frames to be displayed. The fast projector can then use the frame of R0 bits to display the image at T1 and then move on to the R1 pixels for the frame at T2 and so on through projector frame 24 associated with blue bit 7 (B7) at time T24. While the projector is displaying images 1 . . . 24 the new frame is coming into a new buffer so it is ready when the projector has finished with the prior frame. Just as the new frame is loaded, the prior frames have been shown by the projector and the buffers can be switched. Thus, there is a latency because of the pipelined nature of the buffers. This scheme was used at UNC with a standard DLP based projector which, internally, stores two frames of video and swaps buffers at the end of each frame.

Our innovation was to get rid of this latency while still using standard interfaces to the graphics cards and to offer high frame rates. This is accomplished through the unique approach of unrolling each incoming color pixel to have it drive a number of binary pixels on the fast projector. Thus, we compress a 1024×768 binary frame into a block of 1024×32×24 pixels in the frame buffer. Each incoming block of 1024×32×24 pixels is used to create a single 1024×768×1 binary frame. Each time a block of 1024×32×24 arrives, we have enough data to create a new binary image. Thus, instead of having to buffer entire frames of data, and incurring the resulting latency, we need to buffer only a fraction of this data and have much smaller latencies.

Thus, the core idea is that of “unrolling” digital data intended to be delivered to a single pixel and unrolling it to be delivered to several pixels with less bit depth per pixel.

This unrolling technique has been discussed in reference to DVI but applies equally to Camera Link or other graphics interfaces where a pixel with some binary gray scale is transferred and the recipient then uses the data transferred to modulate several pixels in a pre-arranged way. This enables a source device to transfer an image to a device where the bit depths of the transmitter and the recipient do not match—the data is written across the link and interpreted by the receiver as an incoming data stream and used appropriately. Camera Ling for example supports pixels of between 8 bits of intensity to 36 bit RGB where each color component is 12 bits deep. Our approach is to unroll these pixels, effectively creating one bit deep pixels without having to change the underlying standard. This enables greater pixel throughput without having to resort to a custom interface on the PC or computer side of the control link.

### Why Pixel Unrolling is Unique:

1. Designer may allocate the bits as desired—can do a high resolution display with less bit depth without changing anything in the interface from the computer to the display
2. Get low latencies. The latency can be almost zero if the incoming video is matched to the resulting frames.

Note that the “input” and the “output” resolution do not need to match, the unrolling can take place from the incoming data stream—for example, an incoming image of size 2048×1536×24 could drive a 1024 by 768 binary projector with 96 frames.

Note also that the creation of these images can be facilitated on the PC side by a software module which does the rolling of the image, creating a virtual 1024×768×1 frame for the software programmer. Behind the scenes, the software is rolling up the image and packing the RGB pixels of the frame buffer so that when unrolled, a full frame binary image may be created.

This description uses the phrase “binary display” or projector for the output side of this system. The actual output might be any binary type device, a micro mirror device such as a DMD or DLP; an array of LEDs (or the electronics controlling an array of LEDs), a transmissive device, or other binary state device.

### ATTACHED FIGURES & DESCRIPTIONS

FIG. 1—Illustrates the connection of a DVI interface from a computer to a projector.

FIG. 2—Illustration of the bit planes of a graphics image, and showing that this is how, at a marco level, DVI encodes an RGB image. Each pixel is treated as a unit, and is delivered as a unit from the PC to its destination. Each of the RGB components of a pixel are generally 8 to 12 bits in depth on most systems, with a typical total “depth” of 24 bits—8 for R, G, and B.

FIG. 3—Illustrates the representation of a single color frame of video as it might be transferred across standard DVI interfaces. The active image area, composed of “active” pixels, is typically (although not necessarily) enveloped with non active pixels—the blanking area around the active pixels.

FIG. 4—Illustrates the image shown by the DLP, or other optical modulator—it is an array of 1024 by 768 pixels but each pixel is only one bit deep.

FIG. 5—Overview of the unrolling process. The left part of the Figure represents the data from the PC. The DVI interface is shown transferring data to the DLP binary display, and creating a number of them in response to the incoming data.

FIG. 6—Unrolling a 1024 by 768 by 24 bit PC image into 24 frames of 1024 by 768 by 1 images on a binary projector. The PC creates an image in which each set of 32 rows of color pixels is going to create a single 1024 by 768 binary image. Each set of 32 rows comes out of the pc in approximately 694 micro seconds (32*( 1/60)/768 seconds) (actually, it is slower than this with the blanking times). This process is repeated down the entire display. Naturally, if the graphics card timing could be adjusted to have 32 active rows, then there would be just one block of 1024×32×24 which would be unrolled to a 1024×768×1 image.

FIG. 7—This figure illustrates the details of unrolling a single 24 bit medium brown pixel into 24 binary pixels in the first row of the binary display. Clearly, this approach delivers a lot of pixels (albeit binary ones) for the standard incoming data.

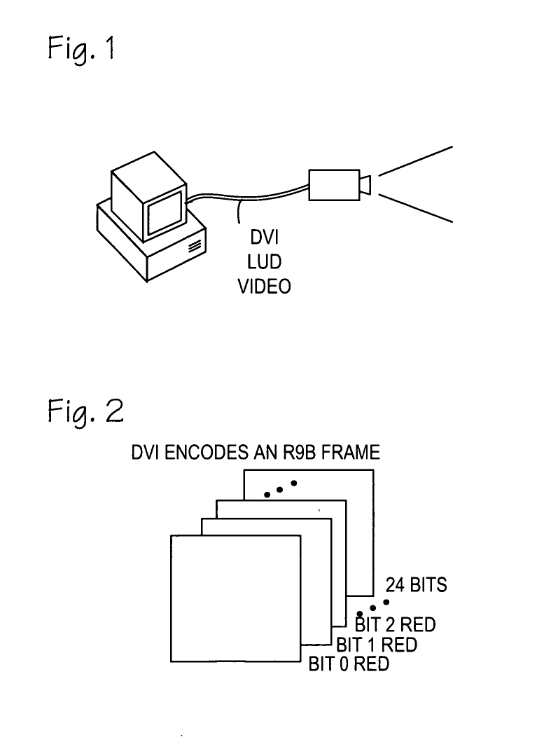

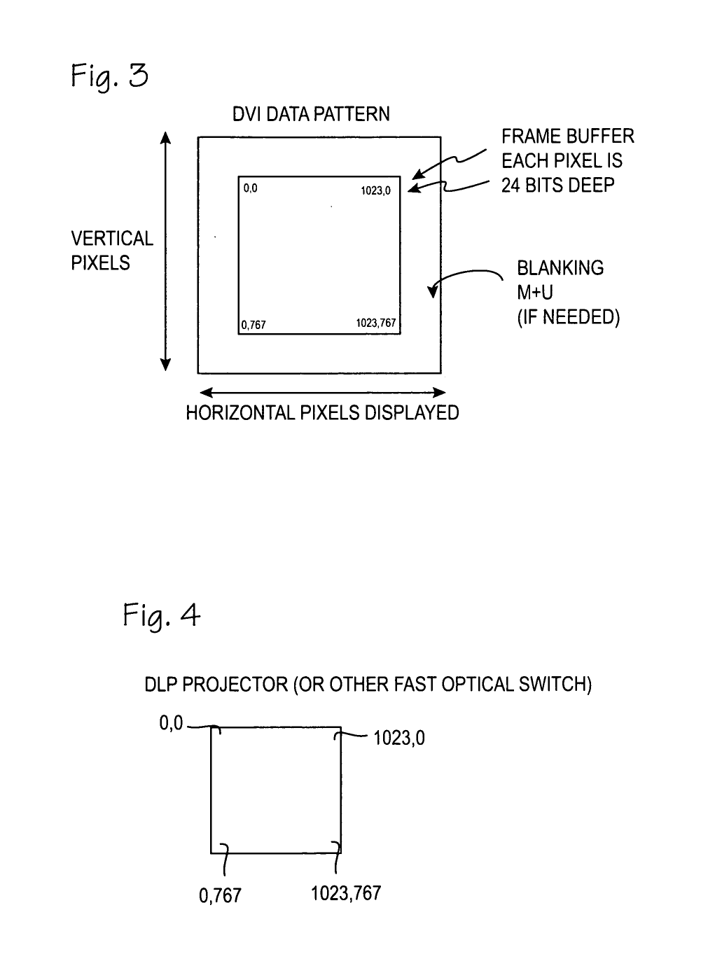

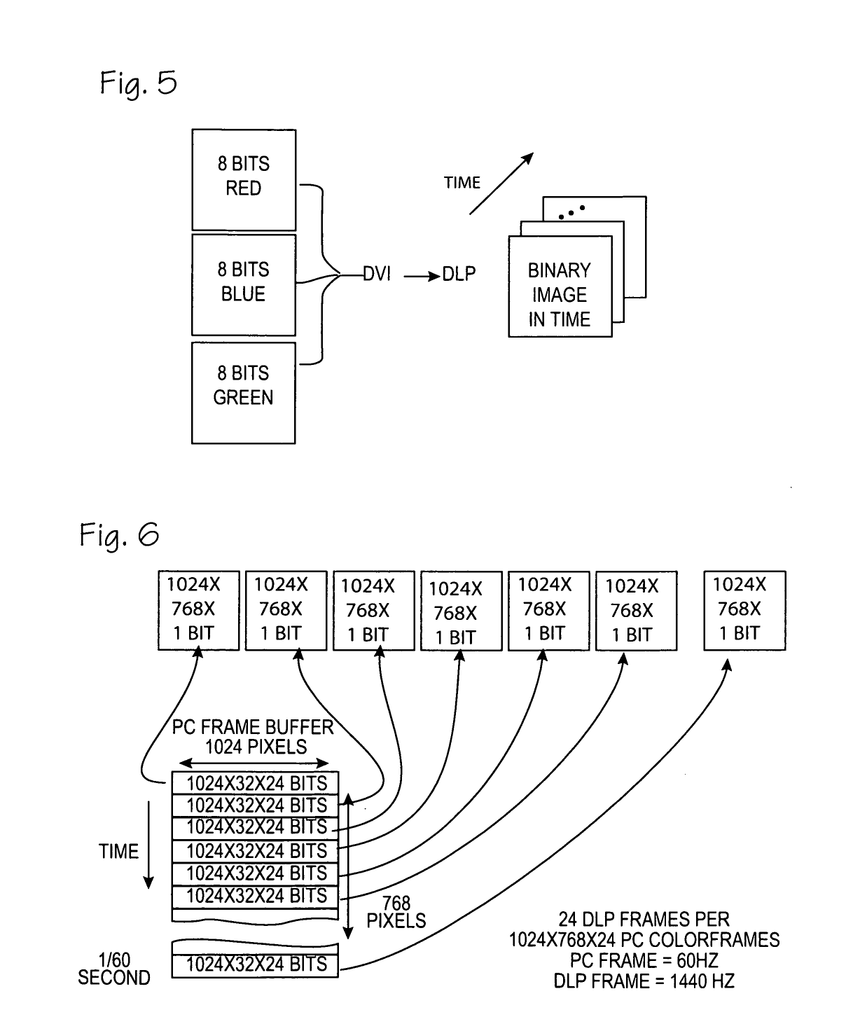

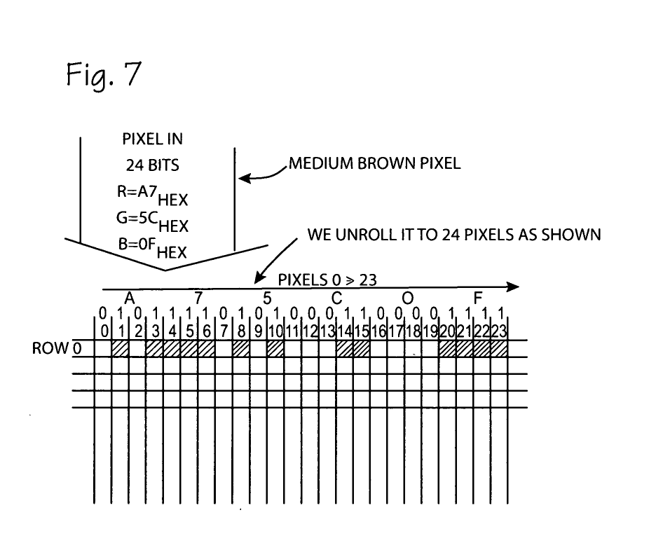

In summary, we have created a means by which one can transfer, using standard interfaces, images of low bit depth to a display or other binary device which runs at a frame rate far in excess of the intended frame rate. This is accomplished by unrolling the pixel data and driving a number of output pixels from the data for a single input pixel. This unrolling results in a higher frame rate on the output side than on the input side because the bit depth has been reduced but the data has all been used.

We claim:

1) Encoding images of reduced bit depth into a standard digital format and displaying said encoded images in decoded form on a DLP device
